(19) United States
(12) Patent Application Publication
(10) Pub. No.: US 2026/0153738 A1
(43) Pub. Date: Jun. 4, 2026

(54) WEARABLE HEADS-UP DISPLAYS INCLUDING COMBINER WITH VISUAL ARTIFACT REDUCTION

(71) Applicant: GOOGLE LLC, Mountain View, CA (US)

(72) Inventors: Nan MA, Oakville (CA); Ian ANDREWS, Kitchener (CA); Nam-Hyong KIM, San Jose, CA (US); Joseph MA, Waterloo (CA); Christopher Charles TOWNSEND, Elora (CA); Vance R. MORRISON, Kitchener (CA); Benjamin WALES, Waterloo (CA); Daniel J. EFFINGER, Hamilton (CA); Geoff WHITE, Kitchener (CA); Tyler G. ANDERSON, Santa Clara, CA (US); Brian Watson CRANTON, Kitchener (CA)

(21) Appl. No.: 19/125,483

(22) PCT Filed: Nov. 1, 2023
(86) PCT No.: PCT/US2023/078344

§ 371 Date: Apr. 29, 2025

Related U.S. Application Data
(60) Provisional application No. 63/422,510, filed on Nov. 4, 2022.
(60) Provisional application No. 63/427,478, filed on Nov. 23, 2022.

(51) Int. Cl. G02B 27/01; G02B 5/00; G02B 27/00; G02B 27/10; G02B 27/14

(52) U.S. Cl. CPC G02B 27/0172; G02B 5/003; G02B 27/0018; G02B 27/102; G02B 27/149; G02B 2027/011; G02B 2027/0114; G02B 2027/0178

(57) ABSTRACT

A wearable heads-up display (WHUD) reduces the prevalence of visual artifacts by employing a projector with a combiner including a plurality of combiner elements such as dichroic prisms. The projector is configured with one or more features that 1) reduce the amount of stray light generated at the combiner 2) change the path of the stray light so that the stray light is unable to exit the projector and thus is unable to create visual artifacts, or any combination thereof. By reducing the stray light that is generated and by changing the path of the stray light as described herein, the likelihood that a user will see a visual artifact is reduced, thus improving the user experience with the WHUD system.

### BACKGROUND

The present disclosure relates generally to augmented reality (AR) eyewear, which fuses a view of the real world with a heads up display overlay. Wearable heads-up displays (WHUDs) are wearable electronic devices that use optical combiners to combine real world and virtual images. The optical combiner may be integrated with one or more lenses to provide a combiner lens that may be fitted into a support frame of a WHUD. In operation, the combiner lens provides a virtual display that is viewable by a user when the WHUD is worn on the head of the user. One class of optical combiner uses a waveguide (also termed a lightguide) to transfer light. In general, light from a projector of the WHUD enters the waveguide of the combiner through an incoupler, propagates along the waveguide via total internal reflection (TIR), and exits the waveguide through an outcoupler. If the pupil of the eye is aligned with one or more exit pupils provided by the outcoupler, at least a portion of the light exiting through the outcoupler will enter the pupil of the eye, thereby enabling the user to see a virtual image. Since the optical combiner lens is transparent, the user will also be able to see the real world.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a portion of an augmented reality (AR) display system, in accordance with some embodiments.

FIG. 2 illustrates a portion of an augmented reality (AR) display system, in accordance with some embodiments.

FIG. 3 illustrates an example of a dichroic prism projector of FIG. 2 in accordance with some embodiments.

FIG. 4 illustrates an example of a dichroic prism projector creating visual artifacts at a WHUD in accordance with some embodiments.

FIG. 5 illustrates an example of a portion of a dichroic prism projector including apertures in dichroic coating to reduce visual artifacts in accordance with some embodiments.

FIG. 6 is a diagram depicting an example of a dichroic prism projector employing a lens to reduce visual artifacts in accordance with some embodiments.

FIG. 7 illustrates example dichroic prism projectors having angled side surfaces to reduce visual artifacts in accordance with some embodiments.

### DETAILED DESCRIPTION

WHUD systems are generally configured to display images via the transfer of light to a user's eye via an optical combiner lens. In many such systems, such as systems having an eyeglass form factor, the lens is placed relatively close to the user's eye. However, at such distances, the user's eye can be particularly sensitive to visual artifacts, such as artifacts resulting from stray light (for example, light that is not properly positioned relative to a source image). Accordingly, it is desirable to reduce the incidence of visual artifacts in a WHUD system while maintaining a relatively small footprint for the projector and other optical components.

To maintain a small footprint, some WHUD systems employ a projector including a combiner having a plurality of combiner elements arranged as cross members in a cubic structures, also referred to as an X-cube. The combiner includes a housing having a generally cubic shape, and includes combiner elements (e.g. prisms) arranged along diagonals of the cubic shape. In some embodiments, each dichroic coatings are sandwiched between each prism to selectively pass or reflect light of specified states, such as light of different colors, different polarizations, and the like. The projector includes panels that generate light of different states (e.g., a red panel, a green panel, and a blue panel) based on a corresponding image to be displayed. The panels are arranged such that each panel transmits light through a different face of the cubic housing, and the dichroic coatings are selected such that each coated surface reflects light of one of the states and transmits light of the other states. For example, in some embodiments the dichroic coating for a first prism reflects red light, and transmits green and blue light, and the dichroic coating for a second prism reflects blue light and transmits green and red light. With this arrangement, the dichroic prism is configured to combine the red, green, and blue light generated by the respective panels into an output beam for transmission (e.g., via a set of lenses) to the incoupler of the WHUD. However, in at least some cases the light of at least one of the panels (e.g., the green light) reflects off some of the faces of the cubic housing, resulting in the combined light including unwanted or “stray” light, and resulting in visual artifacts being projected by the WHUD.

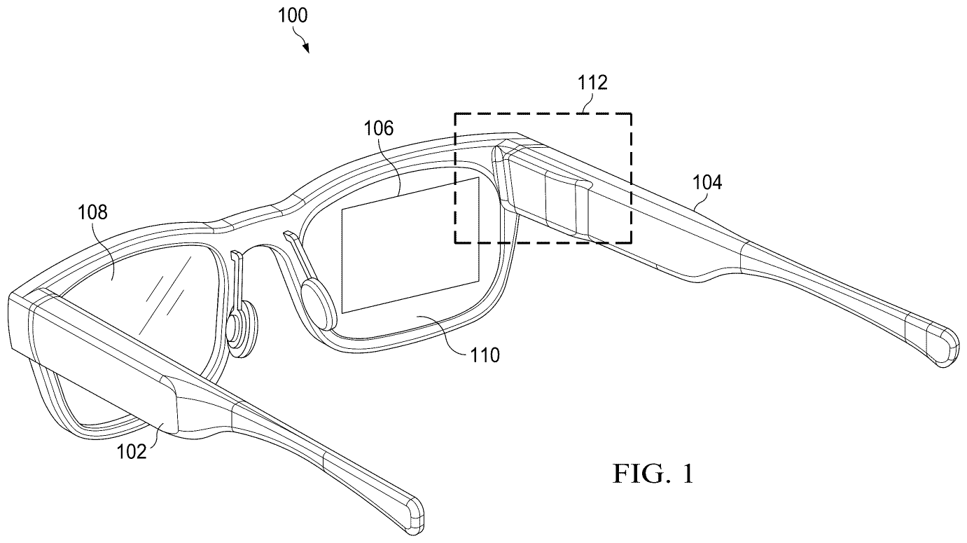

FIGS. 1-7 illustrate techniques for reducing the prevalence of visual artifacts at a WHUD employing a projector with a combiner including a plurality of combiner elements such as dichroic prisms. In some embodiments, the projector is configured with one or more features that 1) reduce the amount of stray light generated at the combiner 2) change the path of the stray light so that the stray light is unable to exit the projector and thus is unable to create visual artifacts, or any combination thereof. By reducing the stray light that is generated and by changing the path of the stray light as described herein, the likelihood that a user will see a visual artifact is reduced, thus improving the user experience with the WHUD system.

To illustrate, in some embodiments the dichroic coatings of the dichroic prism are configured to have apertures over a portion of each prism face. That is, the dichroic coatings are applied so that stray light is absorbed, scattered, reflected, or redirected by the aperture. The apertures are positioned so that the stray light of the specified color does not exit the projector, thereby reducing the likelihood that the light causes visual artifacts.

In some embodiments, a lens is positioned at an output face of the cubic structure. The lens is formed to reflect light that enters the lens at a specified range of angles, such that the light is subjected to total internal reflection and therefore does not exit the projector. In some embodiments, a absorptive surface is positioned outside of the exit face to absorb the reflected light.

In other embodiments, one or more faces of the cubic are angled with respect to an input face for one of the panels (e.g., the green panel). This arrangement causes the input light to be reflected in such a way that at least a portion of the stray light is not transmitted to a projector lens and is therefore not transmitted to the incoupler of the WHUD system. That is, the cubic structure is shaped so that the portion of stray light is unable to reach the exit pupil of the system, and therefore is not seen by the user.

FIG. 1 illustrates an example display system 100 employing an AR optical system in accordance with some embodiments. The display system 100 has a support structure 102 that includes an arm 104, which houses a projector including a dichroic prism structure. The projector is configured to project images toward the eye of a user via a waveguide (not shown here), such that the user perceives the projected images as being displayed through the output coupler in a field of view (FOV) area 106 of a display at the lens element 110. In the depicted embodiment, the display system 100 is a near-eye display system in the form of a WHUD in which the support structure 102 is configured to be worn on the head of a user and has a general shape and appearance (that is, form factor) of an eyeglasses (e.g., sunglasses) frame.

The support structure 102 contains or otherwise includes various components to facilitate the projection of such images toward the eye of the user, such as a projector and a waveguide. In some embodiments, the support structure 102 further includes various sensors, such as one or more front-facing cameras, rear-facing cameras, other light sensors, motion sensors, accelerometers, and the like. In some embodiments, the support structure 102 includes one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1. It should be understood that instances of the term “or” herein refer to the non-exclusive definition of “or”, unless noted otherwise. For example, herein the phrase “X or Y” means “either X, or Y, or both”.

One or both of the lens elements 108, 110 are used by the display system 100 to provide an augmented reality (AR) display in which rendered graphical content can be superimposed over or otherwise provided in conjunction with a real-world view as perceived by the user through the lens elements 108, 110. For example, a projection system of the display system 100 uses light to form a perceptible image or series of images by projecting the display light onto the eye of the user via a projector of the projection system, a waveguide formed at least partially in the corresponding lens element 108 or 110, and one or more optical elements (e.g., one or more retroreflective optical elements, scan mirrors, optical relays, or collimation lenses that are disposed between the projector and the waveguide or integrated with the waveguide), according to various embodiments.

One or both of the lens elements 108, 110 comprises a lens stack having multiple layers, at least one of which layers includes at least a portion of a waveguide that routes display light received by an incoupler of the waveguide to an outcoupler of the waveguide. The waveguide outputs the display light toward an eye of a user of the display system 100. The display light is modulated and projected onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

In some embodiments, the projector of the projection system of the display 100 is a digital light processing-based projector or any combination of a light source, such as a set of lasers or one or more light-emitting diodes (LEDs), and a combiner to combine the light sources into s projected beam of light. In some embodiments, the projector is configured to the projected beam of light (representing an image or portion of an image for display) into the waveguide of the projector. The waveguide expands the display light and outputs the display light toward the eye of the user via an outcoupler.

The projector is communicatively coupled to the controller and a non-transitory processor-readable storage medium or memory storing processor-executable instructions and other data that, when executed by the controller, cause the controller to control the operation of the projector. In some embodiments, the controller controls the projector to selectively set the location and size of the FOV through outcoupler area 106. In some embodiments, the controller is communicatively coupled to one or more processors (not shown) that generate content to be displayed at the display system 100. The projector outputs display light toward the outcoupling area 106 of the display system 100 via the waveguide. In some embodiments, at least a portion of an outcoupler of the waveguide overlaps the FOV area. Herein, the range of different user eye positions that will be able to see the display is referred to as the eyebox of the display.

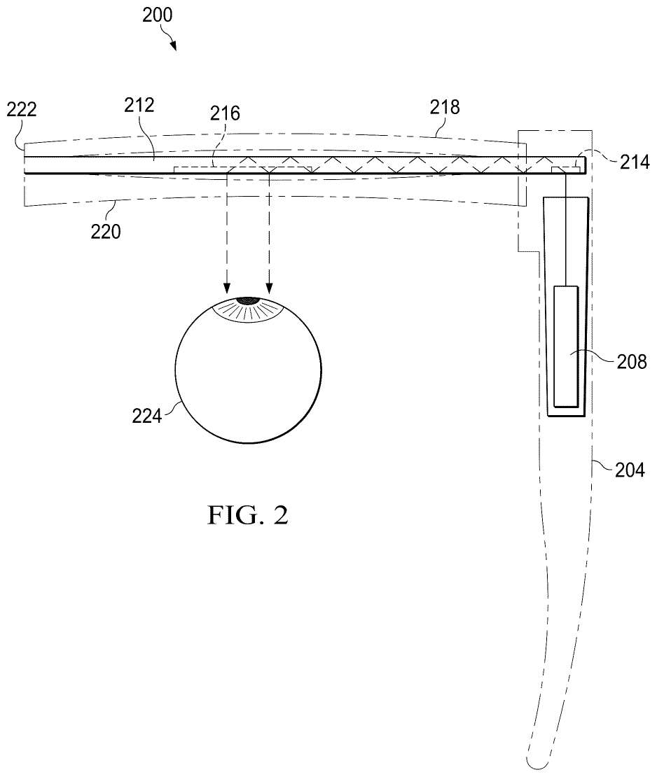

FIG. 2 illustrates a portion of a display system 200 that includes a projection system having a projector 208 and a waveguide 212 with one or more optical paths between an incoupler 214 and an outcoupler 216 of the waveguide 212. In some embodiments, the display system 200 represents the display system 100 of FIG. 1. In the present example, the arm 204 of the display system 200 houses the projector 208, which includes an optical engine (e.g., one or more display panels) with a combiner, the incoupler 214, and a portion of the waveguide 212.

In certain embodiments, the combiner is a cross-dichroic prism, also known as an X-cube. In embodiments, the combiner is configured with one or more features to reduce the effects of stray light on a displayed image, such as one or more of an aperture in a dichroic coating of the prism, a lens to redirect stray light away from the incoupler 214, angled surfaces to direct stray light away from the incoupler 214, and the like.

The display system 200 includes an optical combiner lens 218, which in turn includes a first lens 220, a second lens 222, and the waveguide 212, with the waveguide 212 embedded or otherwise disposed between the first lens 220 and the second lens 222.

Light exiting through the outcoupler 216 travels through the first lens 220 (which corresponds to, for example, an embodiment of the lens element 110 of the display system 100 or portion thereof). In use, the display light exiting the first lens 220 enters the pupil of an eye 224 of a user wearing the display system 200, causing the user to perceive a displayed image carried by the display light output by the projector 208. The optical combiner lens 218 is substantially transparent, such that at least some light from real-world scenes corresponding to the environment around the display system 200 passes through the second lens 222, the waveguide 212, and the first lens 220 to the eye 224 of the user. In this way, images or other graphical content output by the projector 208 are combined (e.g., overlayed) with real-world images of the user's environment when projected onto the eye 224 of the user to provide an AR experience to the user.

The waveguide 212 of the display system 200 includes two diffraction structures: the incoupler 214 and the outcoupler 216. In some embodiments, one or more exit pupil expanders, such as a diffraction grating, is arranged in an intermediate stage between incoupler 214 and outcoupler 216 to receive light that is coupled into the waveguide 212 by the incoupler 214, expand the display light received at one or more exit pupil expanders, and redirect that light towards the outcoupler 216, where the outcoupler 216 then couples the display light out of the waveguide 212 (e.g., toward the eye 224 of the user).

The term “waveguide,” as used herein, will be understood to mean a combiner using one or more of total internal reflection (TIR), specialized filters, or reflective surfaces, to transfer light from an incoupler (such as the incoupler 214) to an outcoupler (such as the outcoupler 216). In some display applications, the display light is a collimated image, and the waveguide transfers and replicates the collimated image to the eye. In general, the terms “incoupler” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, or surface relief holograms. In some embodiments, a given incoupler or outcoupler is configured as a transmissive grating (e.g., a transmissive diffraction grating or a transmissive holographic grating) that causes the incoupler or outcoupler to transmit display light. In some embodiments, a given incoupler or outcoupler is a reflective grating (e.g., a reflective diffraction grating or a reflective holographic grating) that causes the incoupler or outcoupler to reflect light. In the present example, the incoupler 214 relays received display light to the outcoupler 216 via multiple optical paths through the waveguide. In some embodiments, the incoupler 214 redirects a first portion of display light to the outcoupler 216 via a first optical path along which a first exit pupil expander (not shown; implemented as a fold grating in some embodiments) is disposed and redirects a second portion of display light toward the outcoupler 216 via a second optical path along which a second exit pupil expander (not shown; implemented as a fold grating in some embodiments) is disposed. The display light propagates through the waveguide 212 via TIR. The outcoupler 216 then outputs the display light to the eye 224 of the user.

In some embodiments, the projector 208 is coupled to a driver or other controller (not shown), which controls the timing of emission of display light from light sources (e.g., LEDs) of the projector 208 in accordance with instructions received by the controller or driver from a computer processor (not shown) coupled thereto to modulate the output light to be perceived as images when output to the retina of the eye 224 of the user. For example, during operation of the display system 200, the light sources of the projector 208 output light of selected wavelengths, and the output light is directed to the eye 224 of the user via the waveguide 212. The projector 208 modulates the respective intensities of each light source of the projector 208, such that the output light represents pixels of an image. For example, the intensity of a given light source or group of light sources of the projector 208 corresponds to the brightness of a corresponding pixel of the image to be projected by the projector 208 of the display system 200.

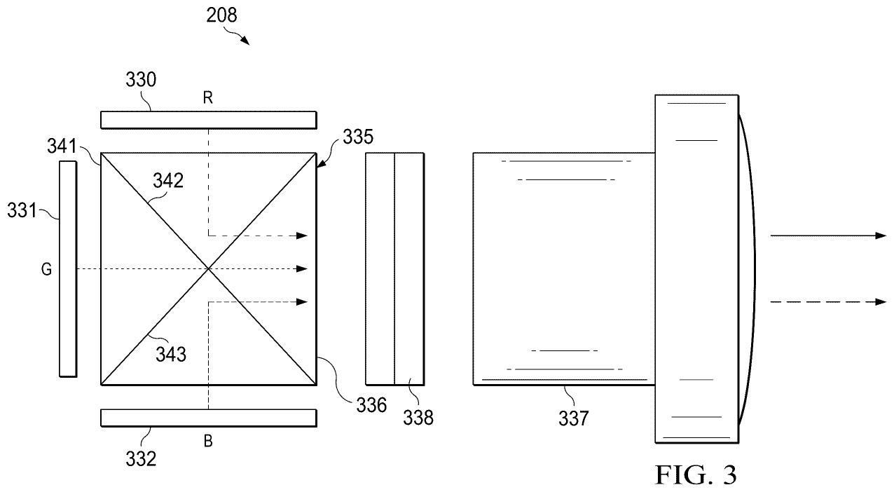

FIG. 3 illustrates an example of the projector 208 in accordance with some embodiments. In the depicted example, the projector 208 includes a set of light sources, including a red light source 330, a green light source 331, and a blue light source 332. The projector 208 also includes a combiner 335, a set of lenses 338, and a projection lens 337. The red light source 330, green light source 331, and blue light source 332 are each configured to generate light of a corresponding color (red, green, and blue respectively) based on a set of instructions or signaling that represent an image to be displayed. In some embodiments the red light source 330, green light source 331, and blue light source 332 are each a panel light source. In other embodiments, the red light source 330, a green light source 331, and blue light source 332 are laser light sources, micro-LED light sources, and the like. It will be appreciated that in various embodiments the light sources 330-332 each provide light of different states, such as different colors (as described above), different polarizations, and the like, or any combination thereof.

The combiner 335 includes a housing having a generally cubic structure, with each of the light sources 330-332 being placed opposite to a corresponding face of the cube, such that light projected by a light source is projected towards the corresponding cube face. For example, the surface 341 of the cube is located opposite the green light source 331. Accordingly, the light projected by each of the light sources 330-332 passes through the corresponding face of the cube to the interior of the combiner 335. Thus, for example, the surface 341 is constructed of a transparent material, so that the surface 341 passes the green light generated by the green light source 331 to the interior of the housing of the combiner 335.

The combiner 335 further includes cross-surfaces 342 and 343, wherein each of the cross-surfaces 342 and 343 is placed along a corresponding body diagonal of the cube. The cross-surfaces 342 and 343 thus form an X shape in the interior of the combiner 335. Furthermore, the cross-surfaces 342 and 343 are constructed of generally transparent material to pass light, and at least a portion of each of the cross-surfaces 342 and 343 is coated with a dichroic coating that reflects light of a corresponding color. In particular, in the example of FIG. 3 the cross-surface 342 is coated with a dichroic coating that reflects red light and transmits green and blue light, and the cross-surface 343 is coated with a dichroic coating that reflects blue light and transmits red light and green light. The effect of this configuration of dichroic coatings is that the red light generated by the red light source 330 and the blue light generated by the blue light source 332 are each reflected by the corresponding cross-surface towards a face 336 of the cube. Furthermore, the cross-surfaces 342 and 343 pass green light, so that the green light generated by the green light source 331 is passed through the surface 341 and towards the face 336. The face 336 is constructed of a transparent material that passes red, green, and blue light. The combiner 335 thus combines the red, green, and blue light into an output beam having all three colors of light and transmits the combined light out of the face 336 of the combiner 335.

In the illustrated embodiment, the face 336 of the combiner 335 is placed opposite the set of lenses 338. Thus, the combined output light of the dichroic prism face 336 is projected towards the set of lenses 338, which modify the direction, optical power, and other characteristics of the output light according to the shape of each of the lenses. The lens 337 receives the light from the set of lenses 338 and projects the received light out of the projector 208 (e.g., towards the incoupler 214). In some embodiments, the set of lenses 338, including the lens edges, apertures and lens barrel also reduce or eliminate stray light as they absorb, block or redirect unwanted light.

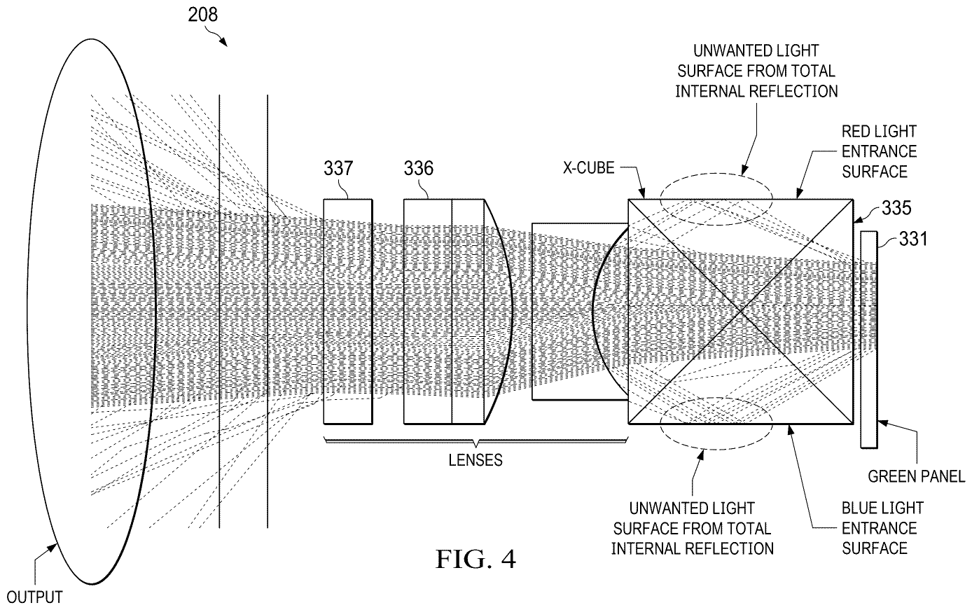

As noted above, in some cases the path of at least some of the light from one or more of the light sources 330-332 is misdirected based on surface reflections at the combiner 335. An example is illustrated at FIG. 4 in accordance with some embodiments. In the depicted example, at least some of the green light generated by the green light source 331 is reflected off the internal surfaces of the cube, including the internal side of the faces opposite the red light source 330 and blue light source 331. The result of this reflection is that a portion of the green light is not located properly within the output beam of the projector 208, at least relative to the image to be projected. For example, in some cases the reflections of the green light (sometimes referred to herein as “stray” light) results in a green “ghost” effect or other visual artifacts in the image projected by the projector 208. To ameliorate the impact of these visual artifacts, in some embodiments, the combiner 335 includes one or more features that reduce the likelihood that the stray light reaches the incoupler 214.

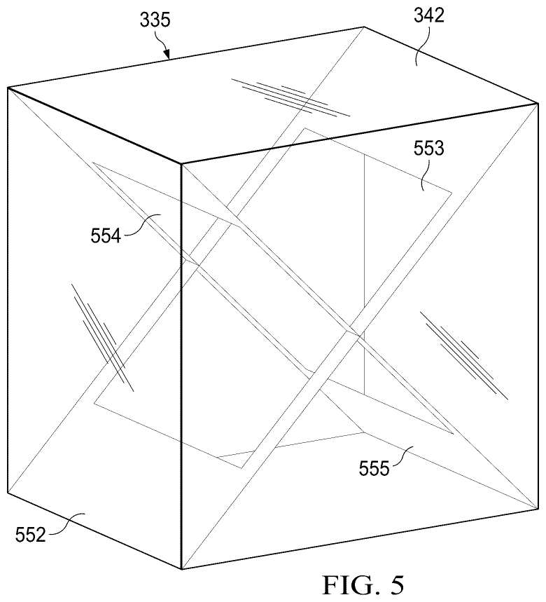

For example, in some embodiments the combiner 335 includes apertures in one or more of the dichroic coatings. The apertures are located on one or more of the cross-surfaces, the faces of the cube, or any combination thereof, and are placed so that the reflections of light off the internal faces of the cube are reduced. An example is illustrated at FIG. 5 in accordance with some embodiments. In the illustrated example, apertures are placed in the dichroic coatings of the cross-surfaces 342 and 343 near the corners of the cube and around a perimeter of each of the cross-surfaces 342 and 343. Thus, the cross-surface 342 includes a coating aperture 552 and a coated region 553 and the cross-surface 343 includes a coating aperture 555 and a coated region 554. The coating apertures 552 and 555 do not include a dichroic coating and therefore reflect, scatter, redirect, or absorb green light, while the coated regions 553 and 554 pass green light. By placing the coating apertures 552 and 555 around the perimeter of the cross-surfaces 342 and 343 respectively, the amount of unwanted green light that reflects off the internal surfaces of the cube is reduced, thereby reducing the amount of stray green light that is projected by the projector 208, and thus reducing the visibility of any artifacts.

The coating apertures 552 and 555 can be created in any of a number of ways. For example, in some embodiments, absorptive coating is applied to the regions corresponding to the coating apertures 552 and 555 after dichroic coating is applied to the entirety of each cross-surface. In some embodiments when the dichroic coatings are applied to the cross-surfaces 342 and 343, a mask is placed over the regions corresponding to the apertures 552 and 555, so that the respective dichroic coating is not applied to these regions. In other embodiments, the dichroic coating is applied to the entirety of each cross-surface, and then the coating is removed, via etching, washing, or other removal techniques, in the regions corresponding to the coating apertures 552 and 555.

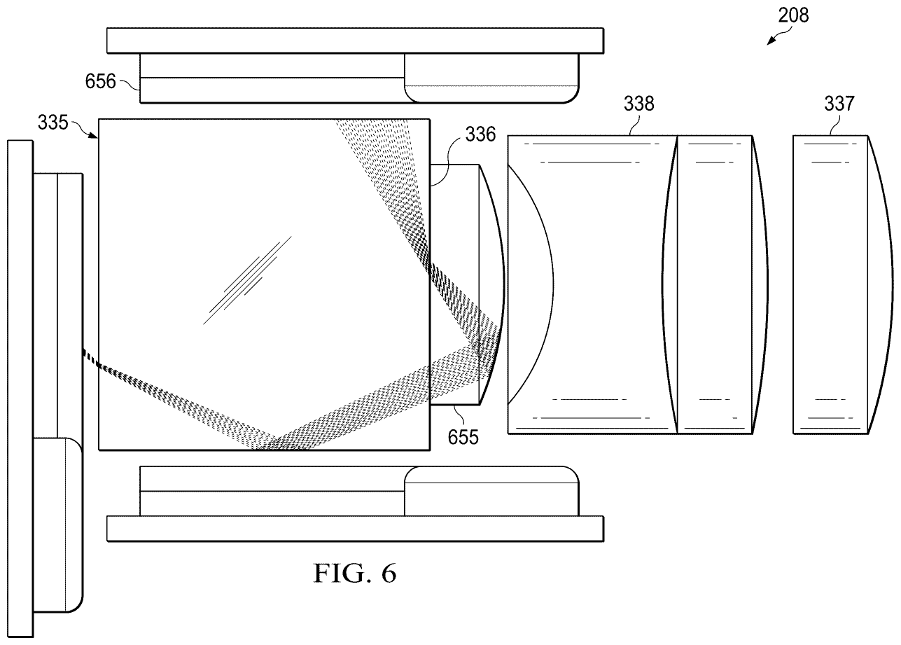

In some embodiments, the projector 208 includes one or more lenses to direct the stray light so that at least a substantial portion of the stray light is not transmitted to the incoupler 214, thereby reducing the likelihood of visual artifacts in the resulting image. An example is illustrated at FIG. 6 in accordance with some embodiments. In the depicted example, the projector 208 includes a lens 655 positioned between the face 336 of the combiner 335 and the lens 338. Thus, the lens 655 is positioned to receive the light output at the face 336, including the stray green light. As shown at FIG. 6, the lens 655 is configured to reflect light back away from the lens 338. That is, the effect of the shape and position of the lens 655 is such that light received at specified angles and locations reflected back towards the combiner 335 and away from the lens 338. However, the shape and position of the lens 655 is such that the light received by the lens 655 at other specified locations and angles is transmitted to the lens 338. In other words, the configuration of the lens 655 is to redirect unwanted light away from the lens 338, and thus away from the incoupler 214, and to transmit the light for display to the lens 338. Accordingly, the stray green light is reflected away from the incoupler 214, and the light corresponding to the image for display is transmitted to the incoupler 214, improving the overall quality of the displayed image.

In some cases the light reflected by the lens 655 could, in turn, be reflected off of other surfaces of the projector 208, and thus potentially cause visual artifacts. Accordingly, to further reduce the likelihood of visual artifacts, in some embodiments the projector 208 includes an absorptive surface 656. The absorptive surface 656 is configured to absorb light of a specified wavelength range, and thus of a particular color. For example, in some embodiments the absorptive surface 656 is configured to absorb green light (that is, light in a wavelength range corresponding to the color green). In some embodiments, the absorptive surface 656 is configured by coating the absorptive surface with a pigment or other material that absorbs light of the corresponding color. The absorptive surface 656 is positioned in the projector 208 to absorb the light reflected by the lens 655. For example, in the embodiment of FIG. 6, the absorptive surface is positioned at or near the light sources 330 and 332. The absorptive surface thus absorbs the green light reflected by the lens 655, reducing the likelihood that the reflected green light will cause visual artifacts or other errors.

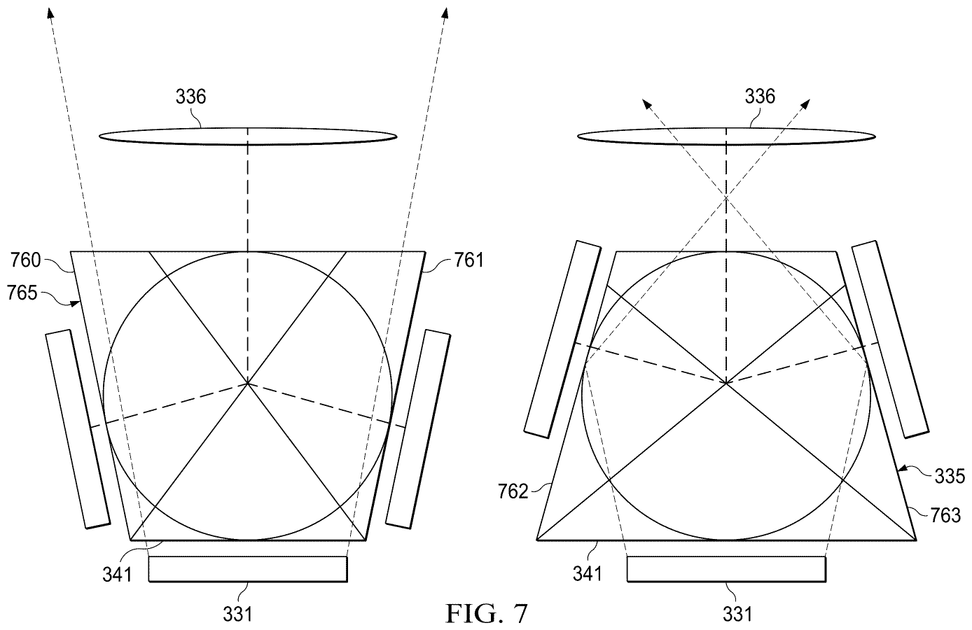

In some embodiments, the shape of the combiner 335 is configured so that the stray light is not transmitted to the incoupler 214. Examples are illustrated at FIG. 7 in accordance with some embodiments. In particular, FIG. 7 illustrates combiners 765 and 766, each having tilted surfaces to direct stray light away from the incoupler 214. For example, combiner 765 includes the surface 341 opposite the light source 331, a surface 760 opposite the light source 330, and a surface 761 opposite the light source 332. The surface 760 and surface 341 are positioned and connected such that the surfaces 760 and 341 form an obtuse angle. Similarly, the surface 761 and surface 341 are positioned and connected such that the surfaces 761 and 341 form an obtuse angle. The effect of this configuration is that some of the green light, and in particular the stray green light, is not transmitted to the lens 338, and therefore is not transmitted to the incoupler 214. Thus, the stray light is not transmitted to the display, reducing the likelihood of ghosts or other visual artifacts.

Dichroic prism 766 includes the surface 341 opposite the light source 331, a surface 762 opposite the light source 330, and a surface 763 opposite the light source 332. The surface 762 and surface 341 are positioned and connected such that the surfaces 762 and 341 form an acute angle. Similarly, the surface 763 and surface 341 are positioned and connected such that the surfaces 763 and 341 form an acute angle. The effect of this configuration is that some of the green light, and in particular the stray green light, is transmitted to the lens 338, but at an angle where the light is not transmitted to the incoupler 214. Thus, the stray light is not transmitted to the display, reducing the likelihood of ghosts or other visual artifacts.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A projector comprising:
a plurality of light sources including a first light source to transmit light of a first state and a second light source to transmit light of a second state; and
a combiner including:
a first cross-surface; and
a first coating on the first cross-surface to transmit light of the first state and reflect light of the second state, the first coating having a first aperture.

2. The projector of claim 1, wherein:
the first state and the second state each comprise a different color of light.

3. The projector of claim 1 wherein the first aperture is to at least one of absorb, reflect, scatter, or redirect light of the first state.

4. The projector of claim 1, wherein the combiner further includes:
a second cross-surface; and
a second coating on the second cross-surface, the second coating having a second aperture.

5. The projector of claim 4, wherein:
the plurality of light sources includes a first light source to transmit light of a first state and a second light source to transmit light of a second state; and wherein the first coating is to transmit light of the first state and reflect light of the second state and the second coating is to transmit light of the first state and reflect light of a third state.

6. The projector of claim 5 wherein the second aperture is to reflect light of the first color.

7. The projector of claim 6, further comprising:
a lens positioned at an output of the combiner; and
wherein the first aperture and the second aperture are positioned so that a portion of the light of the first state does not reach the lens.

8. A projector comprising:
a plurality of light sources including a first light source to transmit light of a first state and a second light source to transmit light of a second state;
a combiner to receive light from the plurality of light sources and provide output light, wherein the combiner includes a first coating to transmit light of the first state and reflect light of the second state; and
a first lens to reflect a first portion of the output light away from the first lens.

9. The projector of claim 8, wherein:
the first state and the second state each comprise a different color of light.

10. The projector of claim 9, further comprising:
an absorptive surface to absorb light of the first state.

11. The projector of claim 10, wherein:
the absorptive surface is positioned to receive the light reflected by the first lens.

12. The projector of claim 9, further comprising:
a second lens, wherein the first lens is to transmit a second portion of the output light to the second lens.

13. The projector of claim 9, wherein the second lens is to transmit the second portion of the light to an incoupler of a waveguide.

14. The projector of claim 8, wherein:
the plurality of light sources includes a first light source to transmit light of a first state and a second light source to transmit light of a second state; and
wherein the first coating is to transmit light of the first state and reflect light of the second state and the second coating is to transmit light of the first state and reflect light of a third state.

15. A projector comprising:
a plurality of light sources; and
a combiner including:
a first cross-surface; and
a housing including a first surface connected to the first cross-surface and a second surface, the first surface and second surface forming one of an acute angle and an obtuse angle.

16. The projector of claim 15, wherein:
the plurality of light sources includes a first light source to transmit light of a first wavelength range associated with a first state and a second light source to transmit light of a second wavelength range associated with a second state; and
wherein the first surface of the housing is to receive light of the first state.

17. The projector of claim 16 wherein the first surface and second surface form an acute angle.

18. The projector of claim 16 wherein the first surface and second surface form an obtuse angle.

19. The projector of claim 15, wherein the housing further includes:
a third surface, the first surface and third surface forming one of an acute angle and an obtuse angle.

20. The projector of claim 19, further comprising:
a lens positioned at an output of the combiner.
